(19) United States
(12) Patent Application Publication
(10) Pub. No.: US 2026/0163971 A1
(43) Pub. Date: Jun. 11, 2026

(54) REFLECTIVE SURFACE DETECTION FOR DISPLAY CONTROL

(71) Applicant: Lenovo (Beijing) Limited, Beijing (CN)

(72) Inventors: Ranjeet Gupta, Aurora, IL (US); Rahul Bharat Desai, Hoffman Estates, IL (US); Binsheng Que, Xiamen (CN)

(73) Assignee: Lenovo (Beijing) Limited, Beijing (CN)

(21) Appl. No.: 19/371,430

(22) Filed: Oct. 28, 2025

Related U.S. Application Data
(63) Continuation of application No. PCT/CN2024/137019, filed on Dec. 5, 2024.

(51) Int. Cl. H04M 1/72454

(52) U.S. Cl. CPC H04M 1/72454; H04M 2250/52; H04M 2250/68

(57) ABSTRACT

In aspects of reflective surface detection for display control, a mobile device may detect, using a sensor, an external reflective surface in view of a camera of the mobile device. The mobile device may disable a first display of the mobile device in response to detecting the external reflective surface. The first display and the camera may be positioned on a same first surface of the mobile device, opposite to a second display positioned on a second surface of the mobile device. In implementations, the mobile device activates the sensor in response to enabling the first display and monitors a region in view of the camera using the sensor. The mobile device may detect a capture event associated with the camera and may store image data captured via the camera in conjunction with disabling the first display. The sensor may include or be an example of a time-of-flight (ToF) sensor.

### RELATED APPLICATION

This application claims priority benefit of Application Number PCT/CN2024/137019 filed 5 Dec. 2024 entitled “Reflective Surface Detection for Display Control,” the disclosure of which is incorporated by reference herein in its entirety.

### BACKGROUND

Electronic devices, such as smartphones and other mobile devices, may include a camera feature that enables the smartphone to capture images of a subject. Using various combinations of sensors, applications, algorithms, and hardware, the camera feature can support functionality such as auto-focus, image stabilization, portrait mode, high dynamic range (HDR), and the like, that facilitate acquisition and generation of high-quality images. Some such functionalities, however, are associated with significant power consumption, central processing unit (CPU) utilization, and thermal strain, particularly in more compact devices. As a result, the smartphone may suffer performance degradation, which can lead to user frustration.

### BRIEF DESCRIPTION OF THE DRAWINGS

Implementations of the techniques for reflective surface detection for display control are described with reference to the following Figures. The same numbers may be used throughout to reference like features and components shown in the Figures.

FIG. 1 illustrates an example system for reflective surface detection for display control in accordance with one or more implementations as described herein.

FIGS. 2-3 illustrate different views of an example mobile device that supports reflective surface detection for display control in accordance with one or more implementations as described herein.

FIG. 4. illustrates an example implementation of reflective surface detection for display control in accordance with one or more implementations of the techniques described herein.

FIGS. 5-6 illustrate example methods for reflective surface detection for display control in accordance with one or more implementations of the techniques described herein.

FIG. 7 illustrates various components of an example device that may be used to implement the techniques for reflective surface detection for display control as described herein.

### DETAILED DESCRIPTION

Implementations of the techniques for reflective surface detection for display control may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for reflective surface detection for display control as described herein. In one or more implementations, a mobile device includes a reflection detection controller, which can be used to implement aspects of the techniques described herein.

Some mobile devices, such as smartphones, feature flexible screens (e.g., organic light-emitting diode (OLED) screens) that allow the device to be folded into various configurations around a pivot axis. Devices having these form factors may be equipped with multiple displays, such that a user is able to access a display regardless of the fold configuration. For example, a foldable mobile device may include a primary display on a first surface (e.g., a front surface of the device) and a secondary display on a second surface opposite the first surface (e.g., on a rear surface of the device).

Such foldable mobile devices often include a camera with one or more image sensors for capturing images and videos of subjects within view of the camera. The mobile device may also include algorithms or other processing methods associated with an application of the camera to analyze, enhance, and optimize images and videos in real-time or post-capture, enabling features such as auto-focus, portrait mode, night mode, and the like. For example, the camera may be located on the rear surface of the mobile device, e.g., along with the secondary display. The mobile device may automatically activate the secondary display when the camera is turned on, allowing a person being photographed to see themselves in the secondary display (a “photo preview”). Additionally, if the photo is being taken in front of a reflective surface (e.g., a window), light emitted by the secondary display may appear as a reflection in the photograph, causing an undesirable degradation in image quality. The mobile device may therefore implement a post-processing algorithm to remove the reflection from the photograph.

However, such features may be associated with relatively high processing and power requirements. Supporting multiple displays active at the same time while also implementing complex algorithms can lead to increased CPU usage, power consumption, and thermal generation. These conditions are further compounded for compact or foldable mobile devices, which may have restricted heat dissipation capabilities and/or battery power due to their physical configurations. For example, the foldable mobile device may be equipped with a relatively small battery compared to a non-foldable mobile device, in order to fit the battery within the form factor. Thus, the battery may drain relatively quickly, the mobile device may overheat, and/or the mobile device may lag or otherwise operate sluggishly. In such examples, user experience can be negatively impacted, leading to frustration.

To address these challenges, the techniques described herein provide for a mobile device to avoid undesirable reflections in photographs without degrading performance. The mobile device includes at least a primary display positioned on a first surface and a secondary display positioned on a second surface, where the second surface also includes a camera of the mobile device. In aspects of the described techniques, the mobile device includes a reflection detection controller that detects, using a sensor of the mobile device, an external reflective surface in view of the camera. In response to the detecting, the mobile device disables the secondary display, thereby avoiding reflection of the secondary display in a subsequently-captured photograph. In implementations, the mobile device disables the secondary display in conjunction with detecting a capture event (e.g., a user pressing a shutter button of the camera) and then reenables the secondary display after the photograph is captured. As such, the techniques described herein support reduced CPU usage, thermal generation, and power consumption without removing or limiting supported features of the mobile device. Additionally, the described techniques prevent a user from having to capture multiple photographs to avoid a reflection artifact, which may conserve battery and memory resources at the mobile device.

While features and concepts of the described techniques for reflective surface detection for display control is implemented in any number of different devices, systems, environments, and/or configurations, implementations of the techniques for reflective surface detection for display control are described in the context of the following example devices, systems, and methods.

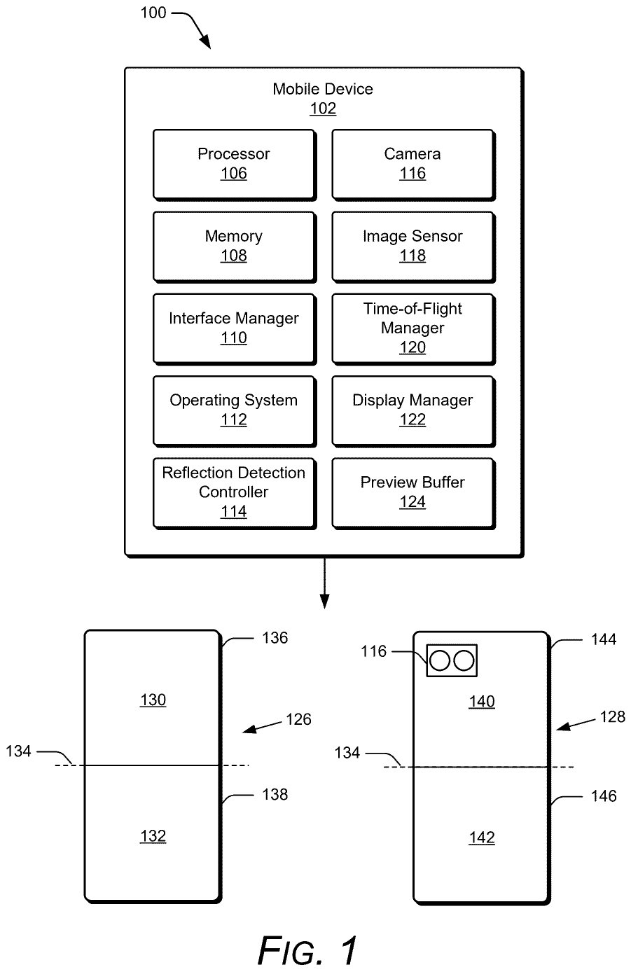

FIG. 1 illustrates an example system 100 for reflective surface detection for display control, as described herein. The system 100 includes a mobile device 102. Examples of the mobile device 102 include at least one of any type of a wireless device, mobile device, mobile phone, foldable device (e.g., foldable phone), flip phone, client device, companion device, tablet, computing device, communication device, entertainment device, gaming device, media playback device, any other type of computing and/or electronic device.

The mobile device 102 can be implemented with various components, such as a processor system and memory, as well as any number and combination of different components such as further described with reference to the example device shown in FIG. 7. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a WiFi radio, a cellular radio, a global positioning satellite (GPS) radio, or any available type of device communication interface.

In some implementations, the devices, applications, modules, servers, and/or services described herein communicate via a communication network, such as for data communication with the mobile device 102. The communication network includes a wired and/or a wireless network. The communication network is implemented using any type of network topology and/or communication protocol, and is represented or otherwise implemented as a combination of two or more networks, to include IP-based networks, cellular networks, and/or the Internet. The communication network includes mobile operator networks that are managed by a mobile network operator and/or other network operators, such as a communication service provider, mobile phone provider, and/or Internet service provider.

The mobile device 102 includes various functionality that enables the device to implement different aspects of reflective surface detection for display control, including a processor 106, a memory 108, an interface manager 110, an operating system 112, a camera 116, an image sensor 118, a time-of-flight (ToF) manager 120, a display manager 122, and a preview buffer 124. In one or more examples, the interface manager 110 represents functionality (e.g., logic and/or hardware) enabling the mobile device 102 to interconnect and interface with other devices and/or networks, such as the communication network. For example, the interface manager 110 enables wireless and/or wired connectivity of the mobile device 102.

The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. An application user interface, or any other type of video, image, graphic, and the like is digital image content that is displayable on the display screen of the mobile device 102.

In the example system 100 for reflective surface detection for display control, the mobile device 102 implements a reflection detection controller 114 (e.g., as a device application and/or a system process). As shown in this example, the reflection detection controller 114 represents functionality (e.g., logic, software, and/or hardware) enabling aspects of the described techniques for reflective surface detection for display control. The reflection detection controller 114 can be implemented as computer instructions stored on computer-readable storage media and can be executed by a processor system of the mobile device 102. Alternatively, or in addition, the reflection detection controller 114 can be implemented at least partially in hardware of the device.

In one or more implementations, the reflection detection controller 114 includes independent processing, memory, and/or logic components functioning as a computing and/or electronic device integrated with the mobile device 102. Alternatively, or in addition, the reflection detection controller 114 can be implemented in software, in hardware, or as a combination of software and hardware components. In this example, the reflection detection controller 114 is implemented as a software application or module, such as executable software instructions (e.g., computer-executable instructions) that are executable with a processor system of the mobile device 102 to implement the techniques and features described herein. As a software application or module, the reflection detection controller 114 can be stored on computer-readable storage memory (e.g., memory of a device), or in any other suitable memory device or electronic data storage implemented with the controller. Alternatively or in addition, the reflection detection controller 114 is implemented in firmware and/or at least partially in computer hardware. For example, at least part of the reflection detection controller 114 is executable by a computer processor, and/or at least part of the content manager is implemented in logic circuitry.

In this example system 100, the reflection detection controller 114 receives electronic communications from various other components included in the system 100 and performs operations based on the received communications. For example, the reflection detection controller 114 can receive input from one or more of these components. Based on the received input, the reflection detection controller 114 can output signals (e.g., electronic signals) to electronic displays of the mobile device 102.

The mobile device 102 may be an example of a foldable device as described herein and may include multiple electronic displays on at least a first surface 126 and a second surface 128 of the mobile device 102. For example, a first electronic display 130 and a second electronic display 132 may be positioned on the first surface 126. The first electronic display 130 and the second electronic display 132 are foldably attached to each other and pivotable relative to each other around a pivot axis 134 (also referred to herein as a fold axis). The first electronic display 130 is integrated with a first housing 136 (e.g., housing portion, member, or section) of the mobile device 102, the second electronic display 132 is integrated with a second housing 138 of the mobile device 102, and the first housing 136 is pivotable relative to the second housing 138 around the pivot axis 134 to pivot (e.g. fold) the first electronic display 130 relative to the second electronic display 132. Content (e.g., media, GUIs, etc.) can be output to extend across both of the first electronic display 130 and the second electronic display 132. In implementations, the first electronic display 130 and the second electronic display 132 can form a single unitary electronic display, such as while the mobile device 102 is in an open configuration. Thus, the first electronic display 130 and the second electronic display 132 may together be understood or referred to as a single electronic display. In at least one implementation the first electronic display 130 and the second electronic display 132 represent a single integrated surface that is foldable in conjunction with movement of the first housing 136 relative to the second housing 138.

Additionally, the mobile device 102 can include at least a third electronic display 140 positioned on the second surface 128. In some examples, the second surface 128 may also include a fourth electronic display 142. The camera 116 may be positioned on the second surface 128 and may be coplanar with the third electronic display 140. The third electronic display 140 is integrated with a third housing 144 of the mobile device 102. When present, the fourth electronic display 142 is integrated with a fourth housing 146 of the mobile device 102; otherwise, the fourth housing 146 does not include an electronic display.

The camera 116 and the image sensor 118 may generate digital images (i.e., digital photographs, digital videos) of subjects within view of the camera 116 and the image sensor 118. The digital images may include red, green, and blue (RGB) color data assigned to pixels of the digital images based on light detected by the image sensor 118. Image data, including the RGB color data, may be stored in the preview buffer 124. When an image is captured (e.g., based on a capture event, such as a user pressing a button or using a voice command), the camera 116 stores the image data from the preview buffer 124 as a digital image. The image sensor 118 may be configured as a digital sensor of the camera 116 integrated with the mobile device 102, where the camera 116 includes a lens, one or more illumination sources (e.g., light-emitting diodes to support a flash function of the camera 116), and/or other components. The image sensor 118 may be configured to utilize the lens of the camera 116 to emit, detect (e.g., receive), and measure light (e.g., visible light, infrared light) from an environment of the mobile device 102. The image sensor 118 can provide data associated with the emitted, detected, and/or measured light as input to the reflection detection controller 114.

In implementations, the image sensor 118 is a ToF sensor associated with a machine learning algorithm of the mobile device 102, such as a machine learning algorithm for removing reflections from generated images. The image sensor 118 may emit infrared light (e.g., as one or more pulses, a continuous wave, or the like), which may reflect off of objects in view of the camera and return to the image sensor 118. The ToF manager 120 determines a time duration between emission of the infrared light and reception of the reflected infrared light at the image sensor 118. Based on the speed of light and the time duration(s), the ToF manager 120 can calculate a distance between the mobile device 102 and any objects off of which the infrared light reflected. For instance, when the image sensor 118 emits multiple pulses of light, the ToF manager 120 may calculate a respective distance corresponding to a respective time duration for each pulse of light. The ToF manager 120 may provide the respective distances and/or the respective time durations to the reflection detection controller 114.

In some examples, the reflection detection controller 114 can utilize the calculated distance(s) to determine a depth map of a digital image acquired by the camera. The reflection detection controller 114 may assign a depth value to each pixel of the digital image. The depth map may be used for one or more features of the mobile device 102, such as auto-focus, reflection detection, and the like. For example, the reflection detection controller 114 may detect that a reflective surface is in view of the camera 116 when the respective distances, or the respective time durations, are relatively equal to one another, (e.g., are within a variance threshold), indicating that the pulses of light have reflected off of a same plane.

The display manager 122 can interface with the reflection detection controller 114 to control the first electronic display 130, the second electronic display 132, the third electronic display 140, and the fourth electronic display 142. For instance, the display manager 122 enables (e.g., activates) the third electronic display 140 when the camera 116 is turned on, and the third electronic display 140 can display a camera preview based on image data in the preview buffer 124. In some examples, the reflection detection controller 114 activates the image sensor 118 in response to (e.g., subsequent to or in conjunction with) enabling the third electronic display 140. The reflection detection controller 114 can then monitor a region in view of the camera 116 using the image sensor 118 to detect whether a reflective surface is present. When the reflection detection controller 114 detects a reflective surface, the display manager 122 may disable (e.g., deactivate) the third electronic display 140 to avoid reflection of the third electronic display 140 in an image captured by the camera 116. In implementations, the reflection detection controller 114 can detect a capture event associated with the camera 116 and can disable the third electronic display 140 in conjunction with storing the image data from the preview buffer 124. After storing the image data, the reflection detection controller 114 may reenable the third electronic display 140.

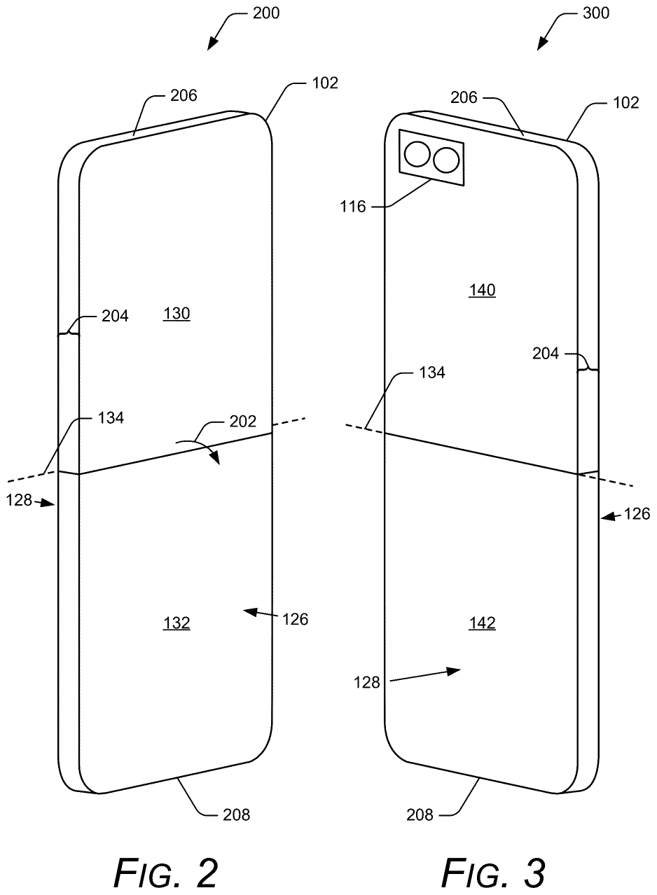

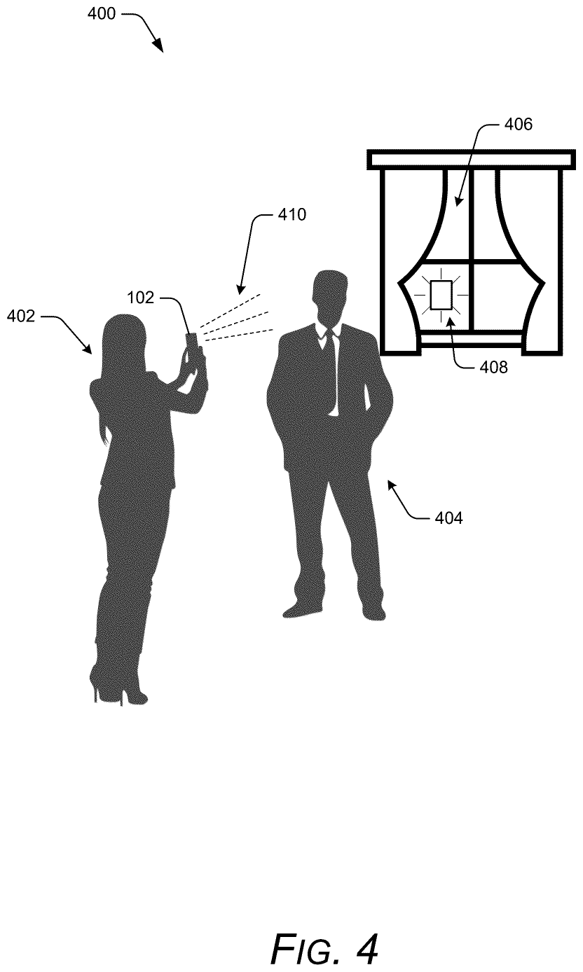

FIGS. 2-3 illustrates different views of the mobile device 102 that supports reflective surface detection for display control, as described herein. The mobile device 102 includes multiple electronic displays that are pivotable relative to each other to adjust the mobile device 102 to different configurations. For example, FIG. 2 and FIG. 3 depict a view 200 and a view 300, respectively, of the mobile device 102 in an “open” configuration. It is to be understood that the configurations shown are non-limiting examples, and other configurations are possible. Other configurations may be achieved by rotating the electronic displays relative to each other, such as around the pivot axis 134 by various angles.

As shown in the view 200, the mobile device 102 includes the first electronic display 130 and the second electronic display 132 separated from each other across the pivot axis 134 of the mobile device 102. The first electronic display 130 is pivotable (e.g., rotatable) relative to the second electronic display 132 around the pivot axis 134 (e.g., in direction 202 around the pivot axis 134). The first electronic display 130 and the second electronic display 132 may be referred to, collectively or individually, as a primary display of the mobile device 102, as content may primarily be displayed on and a user may primarily interact with the first electronic display 130 and the second electronic display 132 (e.g., in contrast to any additional electronic displays).

As shown in the view 300, the mobile device 102 includes a third electronic display 140, the camera 116, and, in some examples, a fourth electronic display 142. The third electronic display 140 is arranged parallel with the first electronic display 130 and is opposite to the first electronic display 130 across a thickness 204 of the mobile device 102. The camera 116 is positioned on the same side of the mobile device 102 and is coplanar with the third electronic display 140. The fourth electronic display 142 is arranged parallel with the second electronic display 132 and is opposite to the second electronic display 132 across the thickness 204 of the mobile device 102. The thickness 204 may be the same at each location along the mobile device 102. The third electronic display 140 and the fourth electronic display 142 may be referred to, collectively or individually, as a secondary display of the mobile device 102.

In the open configuration of the mobile device 102 depicted by FIGS. 2-3, the second electronic display 132 and the first electronic display 130 are arranged parallel and coplanar to each other and spaced apart by the pivot axis 134, while the third electronic display 140 and the fourth electronic display 142 are arranged parallel and coplanar to each other and spaced apart by the pivot axis 134. Further, in the open configuration, the first electronic display 130 and the second electronic display 132 are positioned on the first surface 126 of the mobile device 102, and the third electronic display 140 and the fourth electronic display 142 are positioned on the opposing second surface 128 of the mobile device 102 (e.g., the second surface 128 is opposite to the first surface 126). Additionally, an end 206 of the first electronic display 130 is arranged opposite to an end 208 of the second electronic display 132 across a length of the mobile device 102 perpendicular to the pivot axis 134 and perpendicular to the thickness 204. Although in the open configuration the first electronic display 130, the second electronic display 132, the third electronic display 140, and the fourth electronic display 142 are each parallel to each other, the first electronic display 130 and the second electronic display 132 are not coplanar with the third electronic display 140 and the fourth electronic display 142.

Each electronic display of the mobile device 102 can display content, and in some implementations the displayed content is different for one or more of the electronic displays. During operation of the mobile device 102 in the open configuration, a content output by the mobile device 102 for display can extend across two or more of the electronic displays described above. For example, the content output by the mobile device 102 can be a graphical user interface (GUI), and the GUI can be displayed using both of the first electronic display 130 and the second electronic display 132. In particular, the first electronic display 130 can display a first portion of the GUI (e.g., a first set of elements of the GUI such as panels, menus, etc.) and the second electronic display 132 can display a second portion of the GUI (e.g., a second set of elements). In some situations, a single element of the GUI can be displayed by both of the first electronic display 130 and the second electronic display 132 such that the element appears to extend from the first electronic display 130 to the second electronic display 132 (or vice versa). Additionally, or alternatively, the content output by the mobile device 102 can be displayed using the third electronic display 140 and/or the fourth electronic display 142, e.g., in a similar manner to the first electronic display 130 and the second electronic display 132 as described herein.

Additionally, the mobile device 102 may activate and/or deactivate each electronic display independently of the other electronic displays. For example, when the camera 116 is on, the third electronic display 140 may display a camera preview such that a person being photographed can see themselves as they appear in the camera 116. In accordance with the techniques described herein, the mobile device 102 may monitor a region in front of the camera 116 to perform reflection detection. If the mobile device 102 detects a reflective surface, the mobile device 102 can deactivate (e.g., turn off) the third electronic display 140 (and, if applicable, the fourth electronic display 142) to avoid reflection artifacts in a captured image. In some cases, the mobile device 102 may deactivate the third electronic display 140 in response to detecting a capture event associated with the camera 116, such as when a user presses a shutter button of the camera 116.

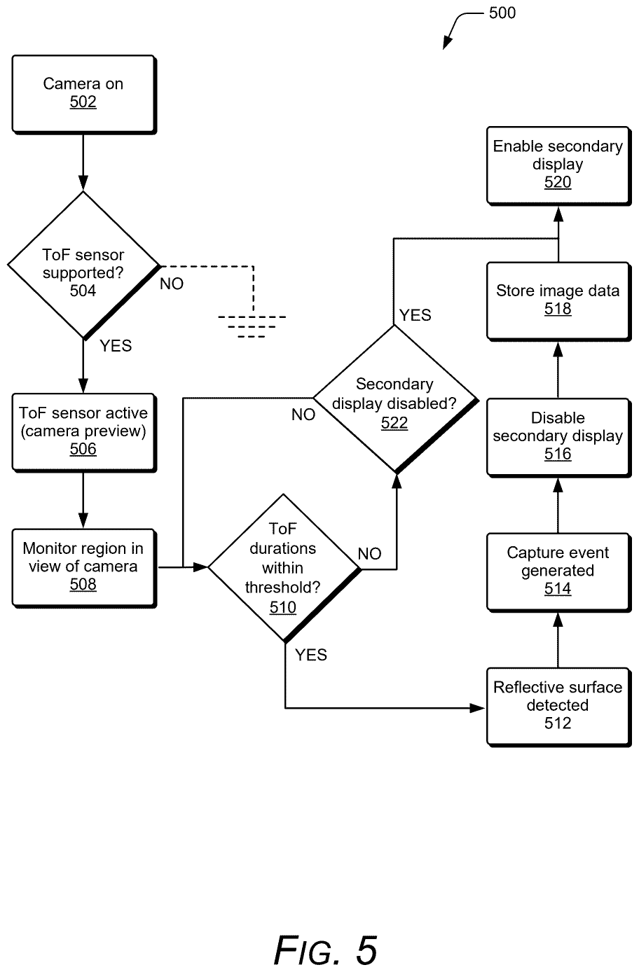

FIG. 4 illustrates an example environment 400 that implements reflective surface detection for display control. The environment 400 can implement or be implemented by the system 100 as described herein. For example, the environment 400 includes the mobile device 102 as described with reference to FIGS. 1-3.

In the environment 400, a user 402 is photographing a subject 404 using the camera of the mobile device 102. The subject 404 is positioned in front of a reflective surface 406, such as a windowpane. When the user 402 activates the camera, a secondary display (such as the third electronic display 140 and/or the fourth electronic display 142) of the mobile device 102, positioned on a same side as the camera, is activated (e.g., enabled) by the mobile device 102. The secondary display may show a preview of the camera's view, enabling the subject 404 to see themselves as they appear through the camera lens. Light emitted from the secondary display reflecting off the reflective surface 406 may cause a reflection 408 to appear on the reflective surface 406.

When the secondary display and/or the camera is activated, the mobile device 102 activates an image sensor (e.g., the image sensor 118) that monitors a region in view of the camera to perform reflection detection, e.g., to determine whether a reflective surface is present. In implementations, the image sensor is a ToF sensor associated with the camera and/or a post-capture algorithm for removing reflections from digital images. The image sensor may emit a set of light pulses 410 and may measure (e.g., calculate) a respective ToF duration for each light pulse. The ToF duration may be defined as a time duration for a pulse of light to be emitted from the image sensor, reflected off of one or more objects in view of the camera, and received at the image sensor. The mobile device 102 can calculate, for each light pulse, a distance between the mobile device 102 and the one or more objects as the product of the ToF and the speed of light. Thus, the mobile device may obtain a set of ToF durations and a set of distances corresponding to the set of light pulses 410.

In implementations, the mobile device 102 monitors the region in view of the camera by continuously emitting light pulses via the image sensor and calculating resulting ToF durations and/or distances while the camera and/or the secondary display are active. In implementations, the set of ToF durations and/or the set of distances are implemented by the mobile device 102 to create a depth map of the environment 400 in view of the camera.

To determine whether a reflective surface, such as the reflective surface 406, is in view of the camera, the mobile device 102 may compare each ToF duration of the set of ToF durations to each other ToF duration of the set of ToF durations. If the difference (e.g., value difference) between each ToF duration is within a threshold (e.g., a variance threshold), the mobile device 102 may determine that the reflective surface is detected 406. As a nonlimiting example, for three light pulses, the set of ToF durations may include 6.60 nanoseconds (ns), 6.50 ns, and 6.55 ns. The variance threshold may be equal to 0.15 nanoseconds. The difference between the first ToF duration and the second ToF duration is equal to 0.10 ns, the difference between the first ToF duration and the third ToF duration is equal to 0.05 ns, and the difference between the second ToF duration and the third ToF duration is equal to 0.05 ns. The difference between each ToF duration is less than 0.15 ns, such that the variance threshold is satisfied. Thus, the mobile device 102 may determine that a reflective surface is detected in view of the camera. Additionally, or alternatively, the mobile device 102 may compare each distance of the set of distances to each other distance of the set of distances in a similar manner as performed for the ToF durations. If the difference (e.g., value difference) between each distance is within a threshold (e.g., a variance threshold), the mobile device 102 may determine that the reflective surface 406 is detected.

In implementations, when the mobile device 102 detects the reflective surface 406, the mobile device 102 may disable (e.g., deactivate) the secondary display surface, which may prevent the reflection 408 from appearing in any images captured by the camera. In some examples, the mobile device 102 may disable the secondary display in response to (e.g., concurrently with and/or subsequent to) the detection. In other examples, the mobile device 102 waits to disable the secondary display until the mobile device 102 detects a capture event at the camera. Here, the mobile device 102 may detect the capture event and disable the secondary display in conjunction with storing image data captured via the camera.

In implementations, the mobile device 102 reenables the secondary display if no reflective surface is detected in view of the camera. For example, if the subject 404 moves to a different position in the environment 400 to be photographed, the mobile device 102 may no longer detect the reflective surface 406 in view of the camera. The mobile device 102 may then reenable the secondary display. Additionally, or alternatively, the mobile device 102 may reenable the secondary display subsequent to detecting a capture event at the camera and/or storing image data captured via the camera.

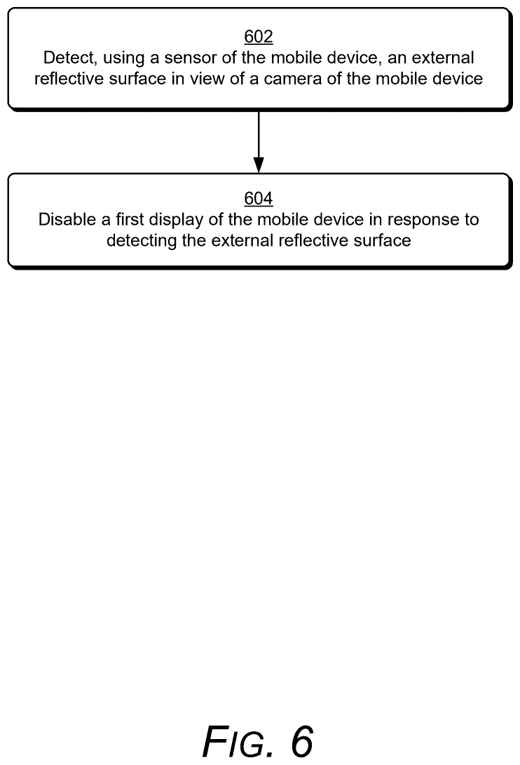

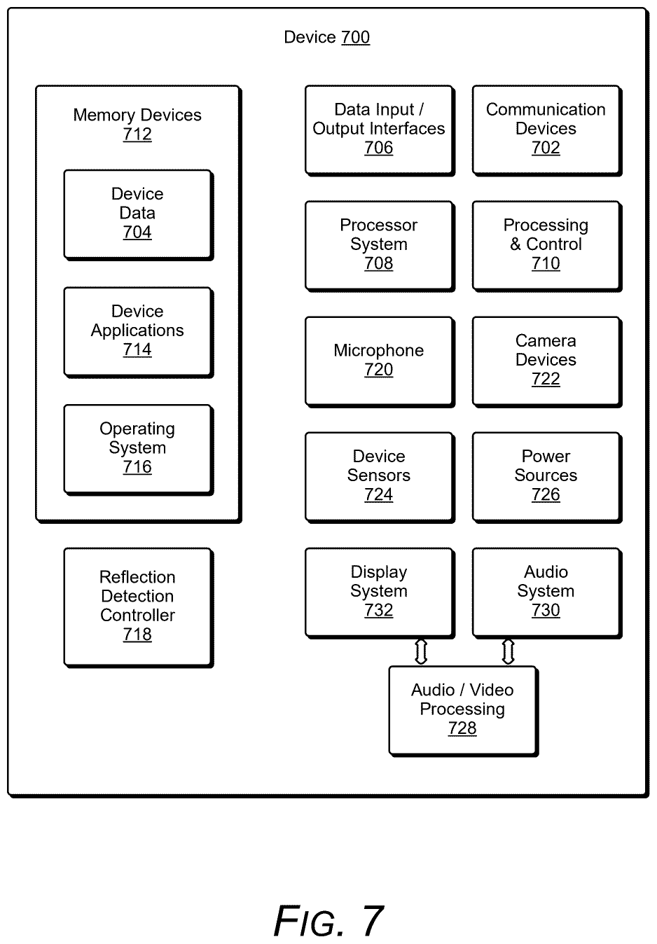

Example methods 500 and 600 are described with reference to respective FIGS. 5 and 6 in accordance with one or more implementations of reflective surface detection for display control, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 for reflection detection for foldable form factors. The order in which the method is described is not intended to be construed as a limitation, and any number or combination of the described method operations may be performed in any order to perform a method, or an alternate method. The method 500 may implement or be implemented by the mobile device 102 as described with reference to FIGS. 1-4.

At 502, a camera of the mobile device 102 is activated. For example, the mobile device 102 may activate the camera 116.

At 504, it is determined whether a ToF sensor is supported. For example, the mobile device 102 may determine whether the image sensor 118, associated with the camera 116, is supported.

At 506, if it is determined that a ToF sensor is supported (e.g., at 504), the ToF sensor is activated. Additionally, at 506, a camera preview may be displayed via a display of the mobile device 102, such as a secondary display.

At 508, a region in view of the camera is monitored. For example, the reflection detection controller 114 may monitor a region in view of the camera 116 using the image sensor 118 and the ToF manager 120 to detect whether a reflective surface is present. The image sensor 118 may emit a set of light pulses (e.g., infrared light pulses) or a continuous wave of infrared light. The ToF manager 120 may calculate a set of ToF durations associated with light emitted from the image sensor 118. In implementations, the ToF manager 120 may calculate a set of distances (e.g., between the mobile device 102 and one or more objects in view of the camera 116) corresponding to the set of ToF durations.

At 510, it is determined whether ToF durations are within a threshold. For example, the ToF manager 120 implemented by the reflection detection controller 114 may compare each ToF duration to each other ToF duration of the set of ToF durations to determine whether the set of ToF durations are within a variance threshold. If the ToF durations are within the threshold, the method 500 proceeds to 512. If the ToF durations are not within the threshold, the method 500 proceeds to 522.

At 512, if the ToF durations are within the threshold, it is determined that a reflective surface is detected. For example, the reflection detection controller 114 may detect a reflective surface based on input from the ToF manager 120 and the image sensor 118.

At 522, it is determined whether a secondary display is disabled. For example, the display manager 122 may determine whether a secondary display of the mobile device 102 is disabled. If not, the method 500 returns to 510. If the secondary display is disabled, the method 500 proceeds to 520.

At 514, a capture event is generated. For example, a user may use a voice command, press a capture button, etc. of the mobile device 102 to capture an image using the camera 116.

At 516, based on the capture event being generated, the secondary display is disabled. For example, the display manager 122 implemented by the reflection detection controller 114 may disable the secondary display.

At 518, in conjunction with disabling the secondary display, image data is stored. For example, the camera 116 may store image data in the preview buffer 124 while the display manager 122 disables the secondary display.

At 520, the secondary display is enabled (e.g., reenabled, reactivated). For example, the display manager 122 may enable the secondary display in response to (e.g., after) the camera 116 storing the image data in the preview buffer 124.

FIG. 6 illustrates example method(s) 600 for reflective surface detection for display control. The order in which the method is described is not intended to be construed as a limitation, and any number or combination of the described method operations may be performed in any order to perform a method, or an alternate method.

At 602, a sensor is used to detect an external reflective surface in view of a camera of a mobile device. For example, the image sensor 118 is used by the reflection detection controller 114 to detect an external reflective surface in view of the camera 116 of the mobile device 102.

At 604, a first display of the mobile device is disabled in response to detecting the external reflective surface. For example, the reflection detection controller 114 utilizes the display manager 122 to disable a display of the mobile device 102.

FIG. 7 illustrates various components of an example device 700, which can implement aspects of the techniques and features for reflective surface detection for display control, as described herein. The example device 700 may be implemented as any of the devices described with reference to the previous FIGS. 1-6, such as any type of a wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-6 may be implemented as the example device 700.

The example device 700 can include various, different communication devices 702 that enable wired and/or wireless communication of device data 704 with other devices. The device data 704 can include any of the various devices, data, and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The data I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a reflection detection controller 718 that implements various aspects of the described features and techniques described herein. The reflection detection controller 718 may be implemented with hardware components and/or in software as one of the device applications 714, such as when the example device 700 is implemented as the mobile device 102 described with reference to FIGS. 1-6. An example of the reflection detection controller 718 is the reflection detection controller 114 implemented by the mobile device 102, such as a software application and/or as hardware components in the mobile device. In implementations, the reflection detection controller 718 may include independent processing, memory, and logic components as a computing and/or electronic device integrated with the example device 700.

The example device 700 can also include a microphone 720 (e.g., to capture an audio recording of a user) and/or camera devices 722 (e.g., to capture video images of the user during a call), as well as device sensors 724, such as may be implemented as components of an inertial measurement unit (IMU). The device sensors 724 may be implemented with various sensors, such as a gyroscope, an accelerometer, and/or other types of motion sensors to sense motion of the device. The device sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 726, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for reflective surface detection for display control have been described in language specific to features and/or methods, the appended claims are not necessarily limited to the specific features or methods described. Rather, the specific features and methods are disclosed as example implementations for reflective surface detection for display control, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one memory; and at least one processor coupled with the at least one memory and configured to cause the mobile device to: detect, using a sensor of the mobile device, an external reflective surface in view of a camera of the mobile device; and disable a first display of the mobile device in response to detecting the external reflective surface.

Alternatively, or in addition to the above-described mobile device, any one or combination of: The at least one processor is further configured to cause the mobile device to: detect a capture event associated with the camera; and store image data captured via the camera in conjunction with disabling the first display. The at least one processor is further configured to cause the mobile device to reenable the first display based at least in part on storing the image data. The at least one processor is further configured to cause the mobile device to: activate the sensor in response to enabling the first display; and monitor, using the sensor, a region in view of the camera to detect the external reflective surface. To detect the external reflective surface, the at least one processor is further configured to cause the mobile device to: calculate a respective time of flight duration for each light pulse of a plurality of light pulses emitted from the sensor; compare the respective time of flight durations to one another; and determine, based on the comparison, that the respective time of flight durations are within a variance threshold. The sensor is a time of flight sensor. The time of flight sensor is associated with a machine learning algorithm to remove at least a portion of a reflection from image data captured by the camera. The first display is positioned on a first surface of the mobile device, and the mobile device further includes a second display positioned on a second surface of the mobile device opposite the first surface of the mobile device. The camera is positioned on the first surface of the mobile device.

A method, comprising: detecting, using a sensor of the mobile device, an external reflective surface in view of a camera of the mobile device; and disabling a first display of the mobile device in response to detecting the external reflective surface.

Alternatively, or in addition to the above-described method, any one or combination of: The method further comprising: detecting a capture event associated with the camera; and storing image data captured via the camera in conjunction with disabling the first display. The method further comprising reenabling the first display based at least in part on storing the image data. The method further comprising: activating the sensor in response to enabling the first display; and monitoring, using the sensor, a region in view of the camera to detect the external reflective surface. The method of claim 10, wherein detecting the external reflective surface comprises: calculating a respective time of flight duration for each light pulse of a plurality of light pulses emitted from the sensor; comparing the respective time of flight durations to one another; and determining, based on the comparison, that the respective time of flight durations are within a variance threshold. The sensor is a time of flight sensor. The time of flight sensor is associated with a machine learning algorithm to remove at least a portion of a reflection from image data captured by the camera. The first display is positioned on a first surface of the mobile device, and the mobile device further includes a second display positioned on a second surface of the mobile device opposite the first surface of the mobile device. The camera is positioned on the first surface of the mobile device.

A system, comprising: at least one memory; and at least one processor coupled with the at least one memory and configured to cause the system to: detect, using a sensor, an external reflective surface in view of a camera of a mobile device; and disable a first display of the mobile device in response to detecting the external reflective surface.

Alternatively, or in addition to the above-described system, any one or combination of: The at least one processor is further configured to cause the system to: detect a capture event associated with the camera; and store image data captured via the camera in conjunction with disabling the first display.

1. A mobile device comprising:
at least one memory; and
at least one processor coupled with the at least one memory and configured to cause the mobile device to:
detect, using a sensor of the mobile device, an external reflective surface in view of a camera of the mobile device; and
disable a first display of the mobile device in response to detecting the external reflective surface.

2. The mobile device of claim 1, wherein the at least one processor is further configured to cause the mobile device to:
detect a capture event associated with the camera; and
store image data captured via the camera in conjunction with disabling the first display.

3. The mobile device of claim 2, wherein the at least one processor is further configured to cause the mobile device to reenable the first display based at least in part on storing the image data.

4. The mobile device of claim 1, wherein the at least one processor is further configured to cause the mobile device to:
activate the sensor in response to enabling the first display; and
monitor, using the sensor, a region in view of the camera to detect the external reflective surface.

5. The mobile device of claim 1, wherein, to detect the external reflective surface, the at least one processor is further configured to cause the mobile device to:
calculate a respective time of flight duration for each light pulse of a plurality of light pulses emitted from the sensor;
compare the respective time of flight durations to one another; and
determine, based on the comparison, that the respective time of flight durations are within a variance threshold.

6. The mobile device of claim 1, wherein the sensor is a time of flight sensor.

7. The mobile device of claim 6, wherein the time of flight sensor is associated with a machine learning algorithm to remove at least a portion of a reflection from image data captured by the camera.

8. The mobile device of claim 1, wherein the first display is positioned on a first surface of the mobile device, and the mobile device further includes a second display positioned on a second surface of the mobile device opposite the first surface of the mobile device.

9. The mobile device of claim 8, wherein the camera is positioned on the first surface of the mobile device.

10. A method performed by a mobile device, the method comprising:
detecting, using a sensor of the mobile device, an external reflective surface in view of a camera of the mobile device; and
disabling a first display of the mobile device in response to detecting the external reflective surface.

11. The method of claim 10, further comprising:
detecting a capture event associated with the camera; and
storing image data captured via the camera in conjunction with disabling the first display.

12. The method of claim 11, further comprising reenabling the first display based at least in part on storing the image data.

13. The method of claim 10, further comprising:
activating the sensor in response to enabling the first display; and
monitoring, using the sensor, a region in view of the camera to detect the external reflective surface.

14. The method of claim 10, wherein detecting the external reflective surface comprises:
calculating a respective time of flight duration for each light pulse of a plurality of light pulses emitted from the sensor;
comparing the respective time of flight durations to one another; and
determining, based on the comparison, that the respective time of flight durations are within a variance threshold.

15. The method of claim 10, wherein the sensor is a time of flight sensor.

16. The method of claim 15, wherein the time of flight sensor is associated with a machine learning algorithm to remove at least a portion of a reflection from image data captured by the camera.

17. The method of claim 10, wherein the first display is positioned on a first surface of the mobile device, and the mobile device further includes a second display positioned on a second surface of the mobile device opposite the first surface of the mobile device.

18. The method of claim 17, wherein the camera is positioned on the first surface of the mobile device.

19. A system comprising:
at least one memory; and
at least one processor coupled with the at least one memory and configured to cause the system to:
detect, using a sensor, an external reflective surface in view of a camera of a mobile device; and
disable a first display of the mobile device in response to detecting the external reflective surface.

20. The system of claim 19, wherein the at least one processor is further configured to cause the system to:
detect a capture event associated with the camera; and
store image data captured via the camera in conjunction with disabling the first display.
